(19) United States
(12) Patent Application Publication
(10) Pub. No.: US 2007/0067633 A1
(43) Pub. Date: Mar. 22, 2007

(54) Method for securely managing an inventory of secure coprocessors in a distributed system

(75) Inventors: Steven J. Pauly, New Milford, CT (US); Robert W. Sisson, Trumbull, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CO (US)

(21) Appl. No.: 11/232,054

(22) Filed: Sep. 21, 2005

(51) Int. Cl. H04L 9/00

(52) U.S. Cl. 713/170

(57) ABSTRACT

A method of managing an inventory of secure coprocessors and processing a plurality of transaction requests in a distributed system having one or more data centers. The method includes maintaining a secure coprocessor control list that includes information identifying one or more of the secure coprocessors, receiving the secure coprocessor control list and one of the transaction requests at one of the data centers, and providing the secure coprocessor control list and the transaction request to a particular secure coprocessor located at the data center. The method further includes allowing the particular secure coprocessor to fulfill the transaction request only if (i) the secure coprocessor control list is able be verified, (ii) the secure coprocessor control list is determined to be fresh, and (iii) information identifying the particular secure coprocessor is included in the information on the secure coprocessor control list.

### FIELD OF THE INVENTION

The present invention relates to distributed computing systems having data centers that utilize secure coprocessors for fulfilling transaction requests, and in particular to a method of managing an inventory of secure coprocessors and processing a plurality of transaction requests in a distributed system through the use of one or more secure coprocessor control lists.

### BACKGROUND OF THE INVENTION

Computerized data centers are widely used in a variety of applications to communicate with, facilitate transactions with, and provide services to individuals, such as customers, through remotely located computing devices, such as personal computers. Such communications, transactions and services often times require the use and transmission of sensitive information and/or are vulnerable to fraud and theft. For example, in many known postage metering systems, postage meters, such as conventional analog or digital meters or personal computer based meters, are able to request and receive postage value refills and/or downloads from a remotely located computer data center.

In order to protect the data and combat fraud and theft, data centers, such as those that provide remote postage refill services, often employ various forms of encryption or the like to ensure a certain level of data and system security. To do so, data centers frequently utilize one or more secure coprocessors in conjunction with a main server computer, wherein the secure coprocessors are provided with the particular encryption keys and algorithms that are necessary in order to provide adequate security for the particular application in question. In these implementations, the secure coprocessors are typically installed at a data center location in an enabled state, and cannot be disabled remotely. This can be problematic in that, if a secure coprocessor were to be removed from the data center and fall into the wrong hands, it could be used fraudulently. For example, a secure coprocessor taken from a data center of a postage refilling system could be used to fraudulently, i.e., without payment, load postage value into a postage meter. Thus, there is a need for a method for securely managing secure coprocessors in an environment such as distributed computing environment wherein the secure coprocessors can easily and efficiently be enabled and disabled remotely.

### SUMMARY OF THE INVENTION

The present invention relates to a method of managing an inventory of secure coprocessors and processing a plurality of transaction requests in a distributed system having one or more data centers. The method includes maintaining a secure coprocessor control list that includes information identifying one or more of the secure coprocessors, receiving the secure coprocessor control list and one of the transaction requests at one of the data centers, and providing the secure coprocessor control list and the transaction request to a particular secure coprocessor located at the data center. The method further includes allowing the particular secure coprocessor to fulfill the transaction request only if (i) the secure coprocessor control list is able to be verified, (ii) the secure coprocessor control list is determined to be fresh, and (iii) information identifying the particular secure coprocessor is included in the information on the secure coprocessor control list. The maintaining step preferably includes adding information identifying a new secure coprocessor to the secure coprocessor control list when the new secure coprocessor is allocated to one of the data centers, and removing information identifying one of the secure coprocessors from the secure coprocessor control list when that secure coprocessor is removed from service.

The method may include storing the secure coprocessor control list at a first location, such as a location of a main server computer, receiving transaction requests at the first location from the transaction requesting party, and sending the secure coprocessor control list to the transaction requesting party after receiving the transaction request at the first location. In addition, the secure coprocessor control list is preferably digitally signed and may be verified using a set of first credentials that are stored at the first location. In this case, the sending step further includes sending the first credentials to the transaction requesting party, and the receiving step further includes receiving the first credentials from the transaction requesting party. The first credentials are then provided to the particular secure coprocessor for use in attempting to verify the secure coprocessor control list.

Moreover, the secure coprocessor control list may be particular to the one of the data centers, or, alternatively, may be associated with all of the data centers (i.e., a master list). Finally, the secure coprocessor control list may include a revision value and/or an effective period, wherein the revision value and/or the effective period are used to determine whether the secure coprocessor control list is fresh.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of a system for metering postage that implements a method for initializing and managing secure coprocessors for use in fulfilling requests for postage refills and/or downloads according to an embodiment of the present invention;

FIG. 2 is a flowchart showing a method of allocating a secure coprocessor to a data center and updating or creating a secure coprocessor control list according to an embodiment of the present invention; and

FIG. 3 is a flowchart showing a method of processing a transaction request according to an embodiment of the present invention.

### DESCRIPTION OF THE PREFERRED EMBODIMENTS

For illustrative purposes, the present invention will be described in connection with a postage metering system that employs a distributed computing environment. However, as will be appreciated, this is meant to be exemplary only, and it should be understood that the present invention may be used in connection with any type of distributed computing environment that makes use of secure coprocessors to service transaction requests.

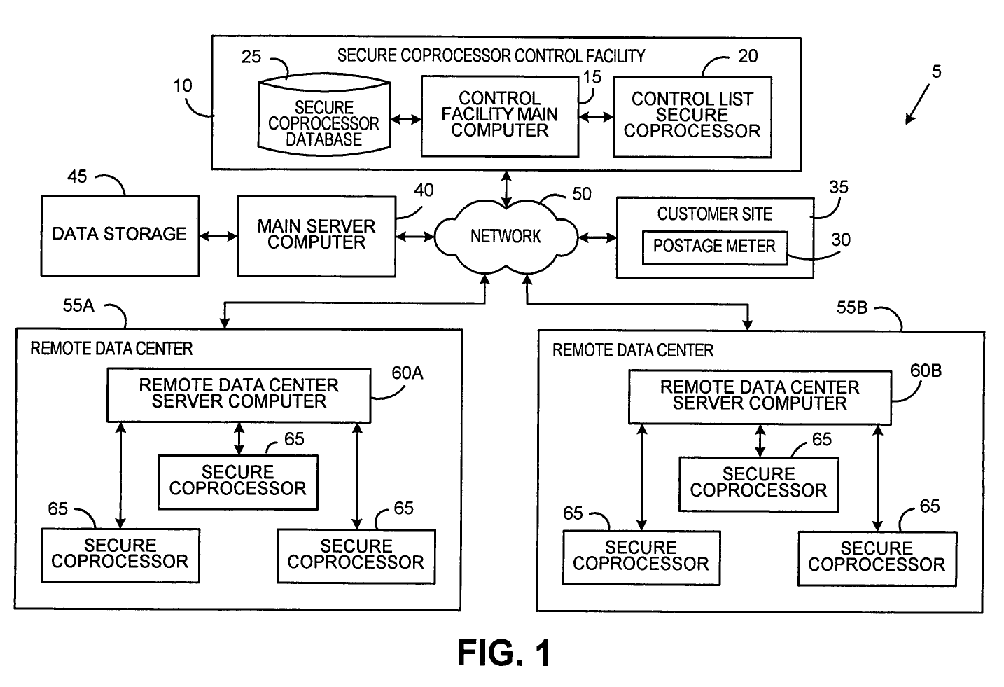

FIG. 1 is a block diagram of a system 5 for metering postage that implements a method for initializing and managing secure coprocessors for use in fulfilling requests for postage refills and/or downloads according to an embodiment of the present invention. The system 5 includes a secure coprocessor control facility 10 that is responsible for fabricating and initializing the secure coprocessors that are to be used in the system 5. The secure coprocessor control facility 10 includes a control facility main computer 15 that is in electronic communication with a control list secure coprocessor 20. The control list secure coprocessor 20 is provided with a public/private key pair for use as described herein. The control facility main computer 15 is also in electronic communication with a secure coprocessor database 25.

The system 5 further includes a postage meter 30 located at a customer site 35. Although only one postage meter 30 and customer site 35 is shown in FIG. 1, it will be appreciated that this is for illustrative purposes only and that multiple postage meters 30 and customer sites 35 may and will be included.

The system 5 also includes a main server computer 40 that is located remotely from the customer site 35. A data storage device 45, described in more detail below, is in electronic communication with main server computer 40. Postage meter 30 and main server computer 40 are able to communicate with one another through network 50, such as the Internet or another suitable communications network. The primary function of main server computer 40 is to receive transaction requests, e.g., requests to refill postage, from postage meter 30 and to direct them appropriately within system 5 for service.

System 5 further includes remote data centers 55A and 55B. Remote data centers 55A and 55B are provided to service the various transaction requests received from postage meter 30 and any other postage meters forming a part of system 5. As will be appreciated, although only two remote data centers 55A and 55B are shown in FIG. 1, a lesser or greater number of remote data centers may also be included depending on the particular application in question. Typically, each remote data center in a distributed computing environment, such as data centers 55A and 55B, is particularly adapted to service requests of a particular type or types, such as from a particular type or model of postage meter 30 or similar device. Thus, as described in greater detail below, one function of the main server computer 40 is to route transaction requests to the appropriate one of the remote data centers 55A and 55B for service thereby.

As seen in FIG. 1, each remote data center 55A, 55B is provided with a remote data center server computer 60A, 60B, each of which is in communication with the postage meter 30 and the main server computer 40 through the network 50. The remote data center server computers 60A and 60B may each be identified and located through the network 50 by a specific service uniform resource locator (URL). In addition, each of the remote data center server computers 60A and 60B is in electronic communication with one or more secure coprocessors 65. As described above, the secure coprocessors 65 are provided with encryption keys and algorithms that enable the associated remote data center server computer 60A, 60B to service and fulfill transaction requests in a secure manner, such as securely providing postage refills.

Before being placed into operation, each secure coprocessor 65 must be initialized by the secure coprocessor control facility 10. Specifically, during initialization, the control facility main computer 15 and control list secure coprocessor 20 together create a data record for each secure coprocessor 65 that, in the preferred embodiment, includes the following data: (i) an identification of the secure coprocessor type, (ii) a unique identifier, such as a serial number, for the secure coprocessor 65, (iii) the date of initialization, (iv) the software version provided with the secure coprocessor 65, and (v) relevant public key material, e.g., a certificate for the control list secure coprocessor 20 to allow secure inter-coprocessor communication. In addition, each record that is created is digitally signed using the private key of the control list secure coprocessor 20. The signed records, once created, are stored in the secure coprocessor database 25 until each secure coprocessor is allocated to a data center (thus becoming a secure coprocessor 65) in the manner described herein.

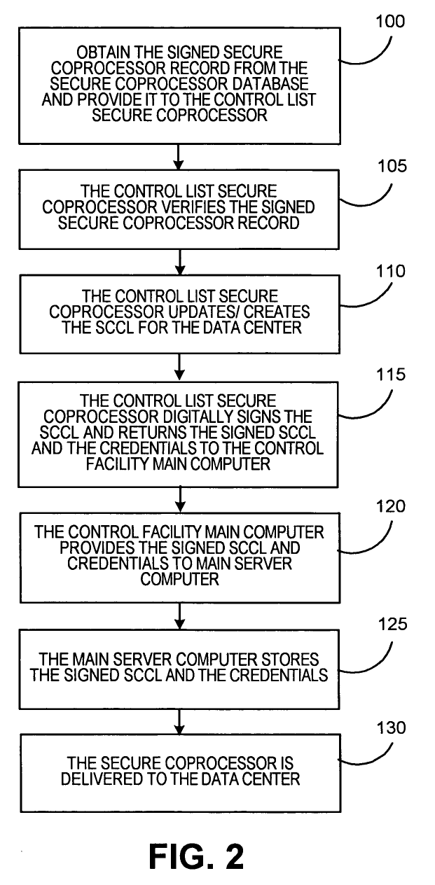

According to the present invention, one or more secure coprocessor control lists (SCCLs) are used to manage an inventory of secure coprocessors 65 in use in system 5, and in particular are used to identify those particular secure coprocessors 65 that are currently authorized to be used in connection with a particular service URL, i.e., a particular remote data center 55A, 55B. FIG. 2 is a flowchart showing a method of allocating a secure coprocessor 65 to a data center 55A, 55B and updating or creating an SCCL according to the present invention. In the embodiment shown in FIG. 2, each remote data center 55A, 55B has its own specific SCCL. This, however, is not required, and instead, a single SCCL may instead be used for all of the remote data centers (e.g., 55A and 55B) in system 5.

At step 100, in response to a request for a new secure coprocessor 65 received from, for illustrative purposes, the data center 55A, the control facility main computer 15 obtains the signed secure coprocessor record for a previously initialized secure coprocessor 65 from the secure coprocessor database 25 and provides it to the control list secure coprocessor 20. At step 105, the control list secure coprocessor 20 verifies the signed secure coprocessor record using the public key corresponding to the private key that was used to sign the record during initialization. Next, at step 110 (if the verification is successful), the control list secure coprocessor updates the existing SCCL (which is in the form of one or more data records) for the requesting remote data center 55A, or if such an SCCL does not yet exist, creates the SCCL for the requesting remote data center 55A. Preferably, this involves adding the identification information for the requesting remote data center 55A and the unique identifier for the secure coprocessor 65 being allocated (which are taken from the signed secure coprocessor record) to the SCCL (existing or new), updating (incrementing) the SCCL revision value, described below, and assigning an effective period for the SCCL (the time period for which the SCCL will be considered valid). According to an aspect of the present invention, the revision value for each SCCL is a value that is updated (incremented) each time that the SCCL is updated. The use of the revision value and effective period will be described in greater detail below.

At step 115, the control list secure coprocessor 20 digitally signs the updated SCCL (for convenience, the term updated SCCL shall refer to both an existing SCCL that has been updated and a newly created SCCL), and returns the digitally signed SCCL and the credentials of the control list secure coprocessor 20 (the credentials include the public key corresponding to the private used to digitally sign the SCCL) to the control facility main computer 15. Then, at step 120, the control facility main computer 15 transmits the digitally signed SCCL and the credentials to the main server computer 40 through the network 50. The main server computer 40 then stores the digitally signed SCCL and the credentials in the data storage device 45 as shown in step 125. Finally, at step 130, the secure coprocessor 65 being allocated is delivered to the requesting remote data center 55A where it is installed and made operable.

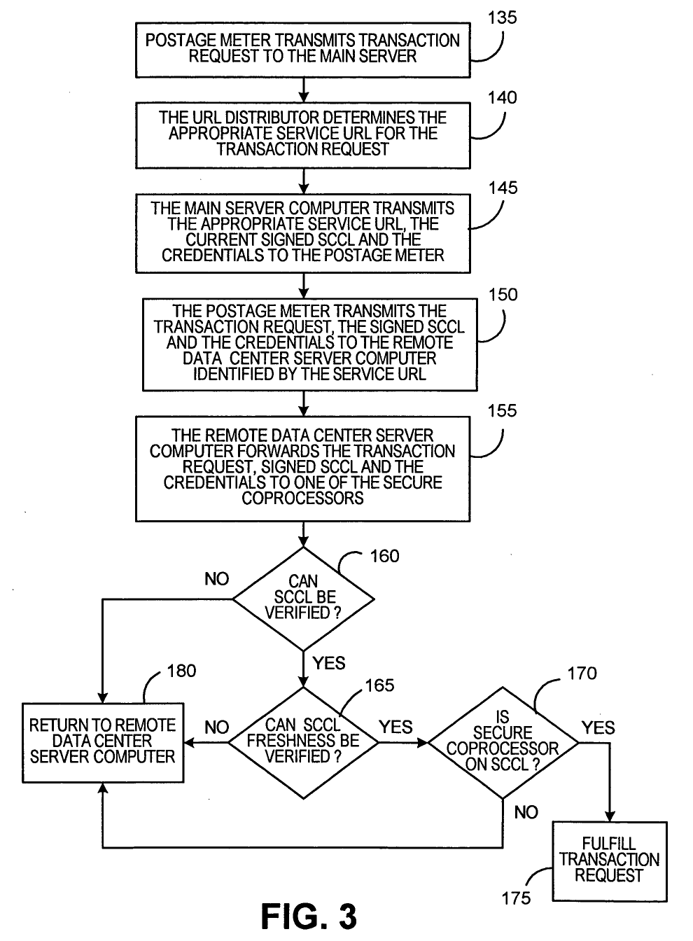

FIG. 3 is a flowchart showing a method of processing a transaction request according to an embodiment of the invention. As noted above, the remote data centers 55A and 55B, and in particular the corresponding remote data center server computer 60A, 60B, may each be identified and located through the network 50 by a specific service URL. All transaction requests from the postage meter 30 are initially directed to the main server computer 40, i.e., the requesting party will use the URL of the main server computer 40 to direct the request, such as by accessing a web site hosted by the main server computer 40. The main server computer 40 is provided with a URL distributor, which is a software process that analyses and routes transaction requests to an appropriate one of the remote data centers 55A and 55B for service thereby.

Thus, referring to FIG. 3, the method begins at step 135, wherein the postage meter 30 transmits a transaction request, such as a request to refill the postage meter 30 with postage value, to the main server computer 40 through the network 50. At step 140, when the main server computer 40 receives the transaction request from the postage meter 30, the URL distributor determines which remote data center, in this example remote data center 55A or 55B, and thus which service URL is appropriate to handle the request. Then, at step 145, the main server computer 40 returns the appropriate service URL, the SCCL for the chosen remote data center 55A or 55B, and the credentials for the control list secure coprocessor 20 (the latter two being stored in data storage device 45) to the postage meter 30 through the network 50. Alternatively, the main server computer 40 can simply forward the transaction request, the SCCL, and the credentials directly to the remote data center server 55A or 55B that will handle the request.

If the transaction request, the SCCL, and the credentials were sent to the postage meter 30, then at step 150 the postage meter 30 transmits the transaction request, the SCCL, and the credentials to the remote data center server 55A or 55B identified by the received service URL. The remote data center server computer 60A or 60B of the identified remote data center 55A or 55B then, at step 155, forwards the transaction request, the SCCL, and the credentials to a selected one of the secure coprocessors 65 connected thereto.

Next, at step 160, a determination is made as to whether the SCCL can be verified using the digital signature and the received credentials. If the answer is yes, then, at step 165, a determination is made as to whether the SCCL is fresh, meaning that it is a proper, up to date version of the SCCL that is appropriate to be used. In the preferred embodiment, this is done by (i) checking the revision value of the SCCL, and (ii) checking that the current date is within the effective period of the SCCL (as noted above, both of these pieces of information are included as part of the SCCL). If either (i) or (ii) is not satisfied, then the SCCL is considered to not be fresh. In the most preferred embodiment, the revision value may be checked as follows. First, if the secure coprocessor 65 has never before received an SCCL, then the revision value of the received SCCL is deemed to be fresh (i.e., the latest revision), the revision value is recorded by the secure coprocessor (for later use), and the checking step ((i) above) is considered to have been satisfied. Second, if a lower revision value is stored by the secure coprocessor 65, then the revision value of the received SCCL is deemed to be fresh (i.e., the latest revision), the revision value is recorded by the secure coprocessor (for later use), and the checking step ((i) above) is considered to have been satisfied. Third, if a higher revision value is stored by the secure coprocessor 65, then the SCCL is deemed to be obsolete, and the checking step ((i) above) is considered to have not been satisfied, and the SCCL is considered to not be fresh.

If the answer at step 165 is yes, then, at step 170, the secure coprocessor 65 parses the SCCL and determines whether its unique identifier and, optionally, its type, are on the list. If the answer is yes, then, according to the SCCL, the secure coprocessor 65 has been determined to be properly enabled and, at step 175, the secure coprocessor 65 fulfills the transaction request. As seen in FIG. 3, if the answer at any of steps 160, 165, or 170 is no, then that means that either the SCCL is not fresh or that the secure coprocessor 65 is not identified as being properly enabled (e.g., it was taken off the SCCL because it was, for some reason, taken out of service), and the method proceeds to step 180, wherein the transaction request is returned to the remote data center server computer 60A or 60B, whichever the case may be, for further processing. This further processing may include targeting other secure coprocessors 65 within the same data center, passing the transaction request on to a fail-over site, or rejecting the transaction request.

As discussed above, the embodiment shown and described in connection with FIGS. 2 and 3 utilizes a separate SCCL for each remote data center, i.e., it utilizes multiple SCCLs that are stored by the main server computer 40 and distributed as needed. It should be understood, however, that the present invention may alternatively be implemented with a single master SCCL that includes information for all of the remote data centers in the system.

Thus, the present invention provides a method in which an inventory of secure coprocessors within a distributed computing environment can be managed, and, in particular, a method by which secure coprocessors can be remotely disabled (i.e., by removing them from the SCCL). As a result, the risk of fraudulent fulfillment of transaction requests is reduced.

While preferred embodiments of the invention have been described and illustrated above, it should be understood that these exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method of managing an inventory of secure coprocessors and processing a plurality of transaction requests in a system having one or more data centers, comprising:
maintaining a secure coprocessor control list, said secure coprocessor control list including information identifying one or more of said secure coprocessors;
receiving said secure coprocessor control list and one of said transaction requests at one of said one or more data centers;
providing said secure coprocessor control list and said one of said transaction requests to a particular secure coprocessor at said data center; and
allowing said particular secure coprocessor to fulfill said one of said transaction requests only if (i) said secure coprocessor control list is able be verified, (ii) said secure coprocessor control list is determined to be fresh, and (iii) information identifying said particular secure coprocessor is included in said information identifying one or more of said secure coprocessors included in said secure coprocessor control list.

2. The method according to claim 1, wherein said receiving step comprises receiving said secure coprocessor control list and said one of said transaction requests at one of said one or more data centers from a transaction requesting party.

3. The method according to claim 2, further comprising storing said secure coprocessor control list at a first location, receiving said one of said transaction requests at said first location from said transaction requesting party, and sending said secure coprocessor control list to said transaction requesting party after receiving said one of said transaction requests at said first location.

4. The method according to claim 3, wherein said secure coprocessor control list is digitally signed and may be verified using first credentials, wherein said first credentials are stored at said first location, wherein said sending step further comprises sending said first credentials to said transaction requesting party, wherein said receiving step further comprises receiving said first credentials from said transaction requesting party, and wherein said providing step further comprises providing said first credentials to said particular secure coprocessor for use in attempting to verify said secure coprocessor control list.

5. The method according to claim 1, wherein said secure coprocessor control list is particular to said one of said one or more data centers and wherein each of said one or more of said secure coprocessors are located at said one of said one or more data centers.

6. The method according to claim 5, wherein said maintaining step comprises adding information identifying a new secure coprocessor to said secure coprocessor control list when said new secure coprocessor is allocated to said one of said one or more data centers, and removing information identifying one of said one or more of said secure coprocessors from said secure coprocessor control list when said one of said one or more of said secure coprocessors is removed from service.

7. The method according to claim 1, wherein said one more data centers comprises a plurality of data centers, wherein said secure coprocessor control list is associated with said plurality of data centers, and wherein a first one of said one or more of said secure coprocessors is located at a first one of said plurality of data centers and a second one of said one or more of said secure coprocessors is located at a second one of said plurality of data centers.

8. The method according to claim 7, wherein said maintaining step comprises adding information identifying a new secure coprocessor to said secure coprocessor control list when said new secure coprocessor is allocated to one of said plurality of data centers, and removing information identifying one of said one or more of said secure coprocessors from said secure coprocessor control list when said one of said one or more of said secure coprocessors is removed from service.

9. The method according to claim 1, wherein said secure coprocessor control list includes a revision value, said revision value being used to determine whether said secure coprocessor control list is fresh.

10. The method according to claim 1, wherein said secure coprocessor control list includes an effective period, said effective period being used to determine whether said secure coprocessor control list is fresh.

11. The method according to claim 1, wherein said secure coprocessor control list includes a revision value and an effective period, said revision value and said effective period being used to determine whether said secure coprocessor control list is fresh.

12. The method according to claim 11, wherein said secure coprocessor control list is determined to be fresh only if a current date falls within said effective period and either said revision value is greater than or equal to a stored revision value stored by said particular secure coprocessor or said particular secure coprocessor does not have a stored revision value.
